(19) United States
(12) Patent Application Publication
(10) Pub. No.: US 2026/0316339 A1
(43) Pub. Date: Oct. 15, 2026

(54) INJECTION MOLDING SYSTEM, INJECTION MOLDING MACHINE, INJECTION MOLDING METHOD, AND PROGRAM

(71) Applicant: SUMITOMO HEAVY INDUSTRIES, LTD., Tokyo (JP)

(72) Inventor: Itta NOZAWA, Yokosuka-shi (JP)

(21) Appl. No.: 19/419,970

(22) Filed: Dec. 15, 2025

(30) Foreign Application Priority Data
Feb. 10, 2025 (JP) 2025-019814

(51) Int. Cl. B29B 13/06

(52) U.S. Cl. CPC B29B 13/065

(57) ABSTRACT

An injection molding system includes: an image capturer configured to image a material for injection molding that has been subjected to preliminary drying before being input to an input port of an injection molding machine, when the material is input to the input port; a measurer configured to measure an amount of moisture contained in the material from a captured image of the material; a determiner configured to determine a treatment for improving the amount of moisture according to the amount of moisture that is measured; and a treatment controller configured to cause the treatment, which is determined, for improving the amount of moisture to be performed.

### CROSS-REFERENCE TO RELATED APPLICATIONS

This application claims priority to Japanese Patent Application No. 2025-019814, filed on Feb. 10, 2025, which is incorporated by reference herein in its entirety.

### BACKGROUND

### Technical Field

Certain embodiments of the present invention relate to an injection molding system, an injection molding machine, an injection molding method, and a program.

### Description of Related Art

A mechanism for adjusting humidity of a material by connecting a hopper and a dryer, measuring a water content in a return gas, and configuring a closed loop of a moisture-adjusted gas has been proposed (see the related art).

### SUMMARY

One or more embodiments provide an injection molding system including: an image capturer configured to image a material for injection molding that has been subjected to preliminary drying before being input to an input port of an injection molding machine, when the material is input to the input port; a measurer configured to measure an amount of moisture contained in the material from a captured image of the material; a determiner configured to determine a treatment for improving the amount of moisture according to the amount of moisture that is measured; and a treatment controller configured to cause the treatment, which is determined, for improving the amount of moisture to be performed.

In addition, one or more embodiments provide an injection molding machine including: an image capturer configured to image a material for injection molding that has been subjected to preliminary drying before being input to an input port, when the material is input to the input port; a measurer configured to measure an amount of moisture contained in the material from a captured image of the material; a determiner configured to determine a treatment for improving the amount of moisture according to the amount of moisture that is measured; and a treatment controller configured to cause the treatment, which is determined, for improving the amount of moisture to be performed.

In addition, one or more embodiments provide an injection molding method including: imaging a material for injection molding that has been subjected to preliminary drying before being input to an input port of an injection molding machine, when the material is input to the input port; measuring an amount of moisture contained in the material from a captured image of the material; determining a treatment for improving the amount of moisture according to the amount of moisture that is measured; and causing the treatment, which is determined, for improving the amount of moisture to be performed.

In addition, one or more embodiments provide a non-transitory computer readable storage medium storing a program that causes a computer to execute a process including: imaging a material for injection molding that has been subjected to preliminary drying before being input to an input port of an injection molding machine, when the material is input to the input port; measuring an amount of moisture contained in the material from a captured image of the material; determining a treatment for improving the amount of moisture according to the amount of moisture that is measured; and causing the treatment, which is determined, for improving the amount of moisture to be performed.

### BRIEF DESCRIPTION OF THE DRAWINGS

FIG. 1 is a diagram showing an example of an overall configuration of an injection molding system to which the present embodiment is applied.

FIG. 2 is a diagram showing an example of a hardware configuration of an injection molding machine constituting the injection molding system of FIG. 1.

FIG. 3 is a diagram showing an example of a functional configuration of a control unit of the injection molding machine.

FIG. 4 is a flowchart showing an example of a flow of a treatment in the injection molding machine.

FIG. 5 is a diagram showing a specific example of an imaging region of an imaging unit.

FIG. 6A is a diagram showing an example of a captured image captured by a hyperspectral camera which is an example of the imaging unit. FIG. 6B is an image obtained by performing primary differentiation on the captured image of FIG. 6A.

FIG. 7 is a graph showing an absorption spectrum in a solid phase and a liquid phase.

### DETAILED DESCRIPTION

However, a technique of detecting drying insufficiency of a material, which is one cause of molding defects, from a captured image of the material captured when the material is input to an input port of an injection molding machine is not known.

It is desirable to detect drying insufficiency of a material from a captured image of the material captured when the material is input to an input port of an injection molding machine.

Herein, the determiner may determine the treatment for improving the amount of moisture in a case where the amount of moisture exceeds a threshold determined in advance.

In addition, the determiner may determine to notify that the amount of moisture exceeds the threshold as the treatment for improving the amount of moisture.

In addition, a preliminary drying machine configured to perform the preliminary drying; and a material returner configured to return the material, which has been subjected to the preliminary drying and has been input to the input port, to the preliminary drying machine may be further included, and the determiner may determine to return the material to the preliminary drying machine with the material returner as the treatment for improving the amount of moisture.

In addition, an additional dryer configured to perform additional drying of the material input to the input port may be further included, and the determiner may determine to cause the additional dryer to perform the additional drying as the treatment for improving the amount of moisture.

In addition, the measurer may divide at least a part of a region of the captured image of the material into a plurality of measurement regions and measures the amount of moisture contained in the material for each of the measurement regions.

In addition, the image capturer may be a multi-wavelength spectroscopic camera.

### Configuration of Injection Molding System 1

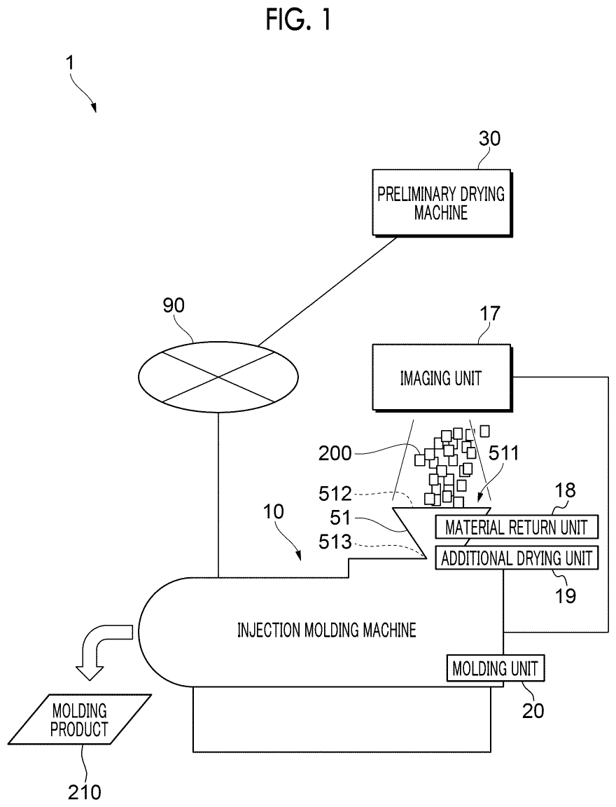

FIG. 1 is a diagram showing an example of an overall configuration of an injection molding system 1 to which the present embodiment is applied.

In an injection molding system 1, an injection molding machine 10 that performs injection molding using a material 200 and a preliminary drying machine 30 that performs a treatment (hereinafter, called “preliminary drying”) for removing moisture contained in the material 200 before being input to the injection molding machine 10 are connected to each other via a network 90. The network 90 is, for example, a local area network (LAN), the Internet, or the like. In the injection molding machine 10 of FIG. 1, an upper side in the drawing represents an upper side in a vertical direction, and a lower side in the drawing represents a lower side in the vertical direction.

### Injection Molding Machine 10

The injection molding machine 10 constituting the injection molding system 1 is a device that enables manufacturing of a molding product 210 through injection molding using the chip-shaped material 200 containing at least a resin. The injection molding machine 10 is provided with an input port 51 for receiving the material 200, which is also called a hopper. The input port 51 includes an opening portion 511 that is widely open toward the upper side in order to receive the material 200 and a storage portion 512 that is a space capable of temporarily storing the material 200. In addition, a discharge port 513 for sending out the material 200 temporarily stored in the storage portion 512 to an inside of the injection molding machine 10 is provided on the lower side of the input port 51 in the vertical direction.

The injection molding machine 10 includes an imaging unit 17 that is imaging means which images the material 200 when the material 200 is input to the input port 51. In addition, the injection molding machine 10 includes a material return unit 18 that is material return means for returning the material 200 temporarily stored in the storage portion 512 to the preliminary drying machine 30 again for preliminary drying. The material return unit 18 will be described later. Hereinafter, the preliminary drying of the material 200 input to the input port 51 will be called “redrying” in which preliminary drying is performed again by the preliminary drying machine 30.

In addition, the injection molding machine 10 includes an additional drying unit 19 that is additional drying means for additionally performing preliminary drying of the material 200 input to the input port 51 separately from preliminary drying performed by the preliminary drying machine 30. Hereinafter, preliminary drying additionally performed separately from preliminary drying performed by the preliminary drying machine 30 will be called “additional drying”. In addition, the injection molding machine 10 includes a molding unit 20 that performs injection molding using the material 200 input to the input port 51.

Herein, necessity of preliminary drying of the material 200 will be described. As described above, preliminary drying is a treatment of removing moisture contained in the material 200 before being input to the injection molding machine 10, and specifically, is a treatment of removing the moisture contained in the material 200 formed of a resin raw material having hygroscopicity. By sufficiently performing preliminary drying of the material 200, occurrence of a molding defect of the molding product 210 caused by insufficient drying of the material 200 is suppressed. Specifically, by sufficiently performing preliminary drying, occurrence of silver streaks (silver-like), bubbles, weld lines, cloudiness, a transparency defect, and the like, which are molding defects caused by insufficient drying, in the molding product 210 can be suppressed.

When preliminary drying is sufficiently performed, occurrence of molding defects caused by insufficient drying can be suppressed. However, when preliminary drying is insufficient, the above molding defects caused by insufficient drying are likely to occur. For this reason, in the present embodiment, drying insufficiency of the material 200 is detected from a captured image of the material 200 captured when the material 200 is input to the input port 51. Then, as a treatment for suppressing occurrence of molding defects caused by the insufficient drying of the material 200, a treatment for improving the amount of moisture contained in the material 200 (hereinafter, called a “moisture amount improvement treatment”) is performed. Details of the moisture amount improvement treatment will be described later.

The imaging unit 17 of the injection molding machine 10 is configured as a camera and images the material 200 when the material 200 is input to the input port 51. The imaging unit 17 is disposed on the upper side in the vertical direction with respect to the input port 51 and images the input port 51 toward the lower side in the vertical direction. For this reason, a target imaged by the imaging unit 17 is a surface of a group of materials 200 temporarily stored in the storage portion 512 of the input port 51, which is on the upper side in the vertical direction. That is, in the present embodiment, for example, the amount of moisture is not measured by bringing the moisture into contact with a measurement object such as a moisture amount sensor in the related art, but the imaging unit 17 images an exposed portion of the material 200 input to the input port 51, and the amount of moisture contained in the material 200 is measured from the captured image. Since the imaging unit 17 only needs to be able to image the surface of the group of materials 200 temporarily stored in the storage portion 512 of the input port 51, which is on the upper side in the vertical direction, the imaging unit 17 may be disposed at a position where the input port 51 can be viewed straight down or may be disposed at a position where the input port 51 can be viewed obliquely down.

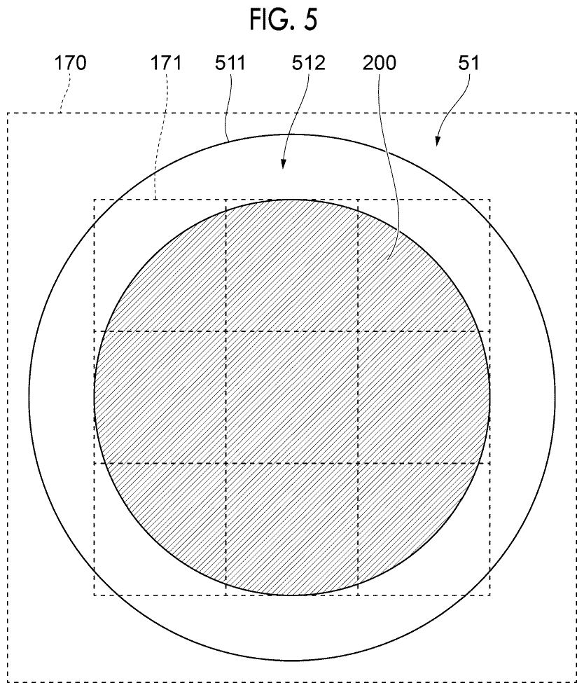

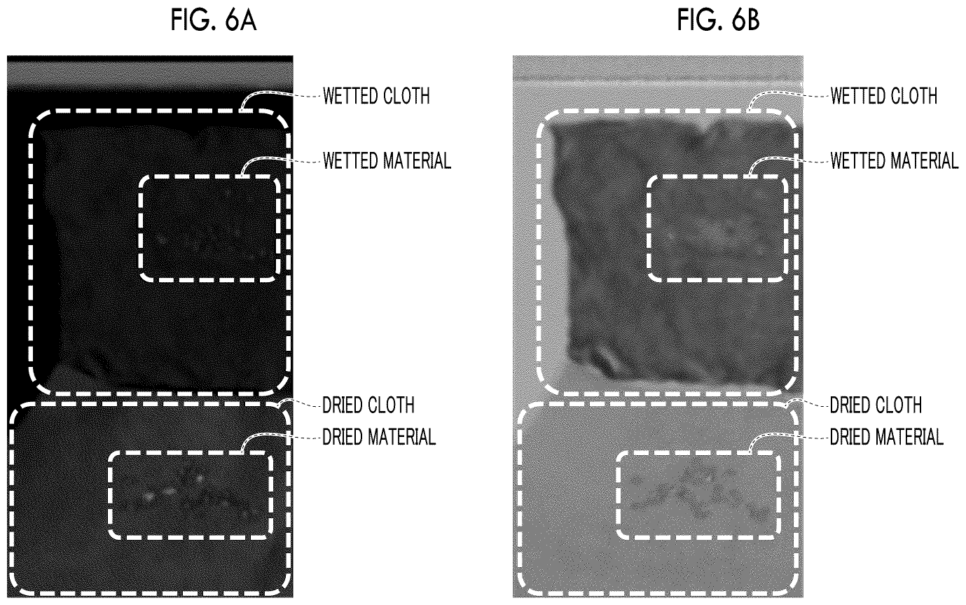

The camera constituting the imaging unit 17 is configured as, for example, a multi-wavelength spectroscopic camera. For example, the multi-wavelength spectroscopic camera includes a hyperspectral camera, a multispectral camera, a camera in which a color filter portion of an RGB camera is changed for a predetermined wavelength, and the like. In a case where a hyperspectral camera is used as the imaging unit 17, for example, a camera sensitive to light having a wavelength of a fundamental wave in the vicinity of 3,000 nm, at which absorption of light mainly caused by OH stretching vibration of water occurs, may be used. In addition, a camera sensitive to light having a wavelength of a second harmonic wave having a half wavelength of the fundamental wave in the vicinity of 1,450 nm may be used. In addition, the camera constituting the imaging unit 17 may be, for example, a single-wavelength infrared camera having a wavelength of only approximately 1,450 nm. The reason for using these cameras will be described later. A specific method of measuring the amount of moisture contained in the material 200 from a captured image of the material 200 will be described later with reference to FIGS. 5 and 6.

The material return unit 18 is a device that returns the material 200 input to the input port 51 of the injection molding machine 10 to the preliminary drying machine 30. The material return unit 18 performs a treatment to return the material 200 to the preliminary drying machine 30 via a pipe of a different system (hereinafter, called a “return pipe”) from a pipe leading to the inside of the injection molding machine 10, which is connected to the discharge port 513 of the input port 51. The material 200 returned to the preliminary drying machine 30 is again input to the preliminary drying machine 30 as a target for redrying.

The additional drying unit 19 is a device that performs additional drying of the material 200 that has been input to the input port 51. For example, the additional drying unit 19 is disposed close to the discharge port 513 of the input port 51 and performs additional drying of the material 200 passing through the discharge port 513. The additional drying unit 19 performs additional drying by removing moisture contained in the material 200 by using various types of drying methods such as a hot air type, a vacuum type, and a dehumidifying type. The material 200 on which additional drying is performed by the additional drying unit 19 is sent to the molding unit 20.

The molding unit 20 performs injection molding using the material 200 sent from the input port 51 and outputs the molding product 210 as a product. The molding unit 20 includes an injection unit that receives the material 200 sent from the input port 51 and that injects the material 200 toward a mold after heating and metering, and a mold that molds the molding product 210 by cooling and solidifying the injected material 200.

In addition, the injection molding machine 10 can execute application software that makes the injection molding system 1 usable and also functions as an information processing device that performs various types of processing. For example, the injection molding machine 10 measures the amount of moisture contained in the material 200 from a captured image of the material 200 captured by the imaging unit 17 and determines the moisture amount improvement treatment according to the measured amount of moisture. For example, the injection molding machine 10 may determine the moisture amount improvement treatment in a case where the amount of moisture contained in the material 200 exceeds a threshold determined in advance.

In this case, the “threshold determined in advance” may be calculated, for example, based on a record related to molding defects caused by drying insufficiency of the material 200 that has occurred in the past, results of various types of experiments separately performed, or the like. For this reason, the “threshold determined in advance” may be determined, for example, as a degree at which molding defects caused by drying insufficiency of the material 200 are predicted. In addition, the “threshold determined in advance” may be determined to have a margin to a degree at which occurrence of molding defects caused by drying insufficiency of the material 200 can be prevented in advance.

The injection molding machine 10 determines a treatment such as the following as the moisture amount improvement treatment. That is, the injection molding machine 10 may determine to notify a worker that the amount of moisture contained in the material 200 exceeds a threshold determined in advance as the moisture amount improvement treatment. In addition, a determination to stop operation of the injection molding machine 10 may be made. In this case, the “threshold determined in advance” described above is determined to be a degree at which molding defects caused by drying insufficiency of the material 200 can be predicted. Accordingly, when the amount of moisture contained in the material 200 exceeds the threshold determined in advance, it is determined to notify the worker of this fact.

In addition, the injection molding machine 10 may determine to return the material 200 to the preliminary drying machine 30 without stopping operation of the injection molding machine 10 as the moisture amount improvement treatment. In this case, the “threshold determined in advance” described above is determined, for example, to have a margin to a degree at which occurrence of molding defects caused by drying insufficiency of the material 200 can be prevented in advance. Accordingly, the injection molding machine 10 determines to return the material 200 to the preliminary drying machine 30 without stopping operation of the injection molding machine 10 when the amount of moisture contained in the material 200 exceeds the threshold determined in advance.

In addition, the injection molding machine 10 may determine to perform additional drying of the material 200 without stopping operation of the injection molding machine 10 as the moisture amount improvement treatment. In this case, the “threshold determined in advance” described above is determined, for example, to have a margin to a degree at which occurrence of molding defects caused by drying insufficiency of the material 200 can be prevented in advance. Accordingly, the injection molding machine 10 determines to perform additional drying of the material 200 without stopping the operation of the injection molding machine 10 when the amount of moisture contained in the material 200 exceeds the threshold determined in advance.

When the moisture amount improvement treatment is determined, the injection molding machine 10 performs the moisture amount improvement treatment of the determined content. For example, the injection molding machine 10 notifies the worker of the fact that the amount of moisture contained in the material 200 exceeds the threshold determined in advance as the moisture amount improvement treatment. In this case, for example, the injection molding machine 10 may output an alert indicating that the amount of moisture contained in the material 200 exceeds the threshold determined in advance.

Herein, a method by which the injection molding machine 10 outputs an alert is not particularly limited. For example, the injection molding machine 10 may output a warning sound for notifying that the amount of moisture contained in the material 200 exceeds the threshold determined in advance from a speaker. Accordingly, the worker can be notified of the fact that the amount of moisture contained in the material 200 exceeds the threshold determined in advance in an auditory manner. In addition, for example, the injection molding machine 10 may display text information indicating that the amount of moisture contained in the material 200 exceeds the threshold determined in advance on a display. Accordingly, the worker can be visually notified of the fact that the amount of moisture contained in the material 200 exceeds the threshold determined in advance.

In addition, for example, the injection molding machine 10 performs a treatment to return the material 200 having the amount of moisture exceeding the threshold determined in advance to the preliminary drying machine 30 as the moisture amount improvement treatment. Specifically, the injection molding machine 10 returns the material 200 in a state of being input to the input port 51 to the preliminary drying machine 30 via the material return unit 18. In this case, the preliminary drying machine 30 performs redrying of the material 200 returned from the injection molding machine 10 via the material return unit 18. The material 200 that has been redried by the preliminary drying machine 30 is again input to the input port 51 of the injection molding machine 10 and is imaged by the imaging unit 17.

In addition, for example, the injection molding machine 10 causes the additional drying unit 19 to perform additional drying of the material 200 as the moisture amount improvement treatment. In this case, the additional drying unit 19 performs the additional drying of the material 200 passing through the discharge port 513. The material 200 that has been additionally dried by the additional drying unit 19 is used for injection molding by the molding unit 20 as a sufficiently dried material.

### Preliminary Drying Machine 30

The preliminary drying machine 30 that constitutes the injection molding system 1 is a device that performs preliminary drying of the material 200 before being input to the injection molding machine 10. The preliminary drying machine 30 performs preliminary drying by removing moisture contained in the material 200 using various types of drying methods such as a hot air type, a vacuum type, and a dehumidifying type with respect to the material 200 that has been input to the machine. The material 200 that has been subjected to preliminary drying is sent toward the injection molding machine 10 via a pipe (not shown) and is input to the input port 51.

When the material 200 is returned via the material return unit 18 of the injection molding machine 10, the returned material 200 is redried by the preliminary drying machine 30. Then, when the redrying of the material 200 is completed, the preliminary drying machine 30 sends the material 200 toward the injection molding machine 10 again. The preliminary drying machine 30 may be controlled so that operation is performed by the injection molding machine 10 or may operate independently of the injection molding machine 10.

The above-described treatment performed by each of the injection molding machine 10 and the preliminary drying machine 30 constituting the injection molding system 1 is merely an example. In addition, the injection molding machine 10 may be a single device or may be a combination of a plurality of devices. Furthermore, a part thereof may be built on the cloud. Since the injection molding system 1 may have a function of realizing the above-described treatment as a whole system, a part or all of the functions of realizing the above-described treatment may be shared or may cooperate with each other in the injection molding system 1.

For example, a part or all of the functions of the injection molding machine 10 may be used as the functions of another device (for example, the preliminary drying machine 30) in the injection molding system 1. In addition, a part or all of the functions of another device in the injection molding system 1 may be used as the functions of the injection molding machine 10. Furthermore, a part of the functions of the injection molding machine 10 may be transferred to another server (not shown) or the like. Accordingly, treatments of the injection molding system 1 as a whole are promoted, and the treatments can complement each other.

### Hardware Configuration of Injection Molding Machine 10

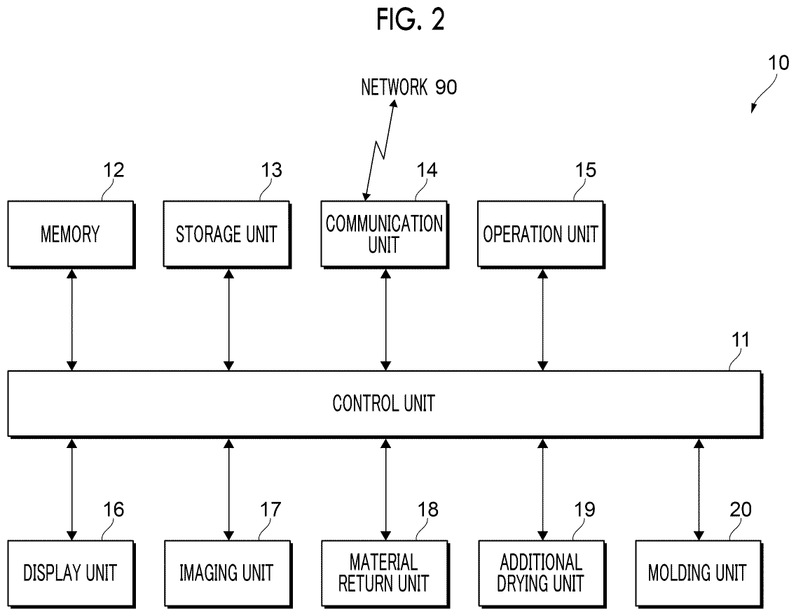

FIG. 2 is a diagram showing an example of a hardware configuration of the injection molding machine 10 constituting the injection molding system 1 of FIG. 1.

In addition to the imaging unit 17, the material return unit 18, the additional drying unit 19, and the molding unit 20 described with reference to FIG. 1 described above, the injection molding machine 10 includes a control unit 11, a memory 12, a storage unit 13, a communication unit 14, an operation unit 15, and a display unit 16. The imaging unit 17, the material return unit 18, the additional drying unit 19, and the molding unit 20 including these units are connected to each other by a data bus, an address bus, a Peripheral Component Interconnect (PCI) bus, or the like.

The control unit 11 is a processor that controls the functions of the injection molding machine 10 through execution of various types of software such as an OS (basic software) and application software (application programs). In the case of the present embodiment, various types of processing are executed by any computer. Any computer may be realized as a processor that is hardware, a program that is software, or a combination thereof. Any computer may be a general-purpose computer, a computer for a specific purpose, a workstation, or another system that can execute each processing.

The processor is configured to execute various types of processing in cooperation with a program. The processor can function as each unit or each means in the present embodiment. Execution order of the processing by the processor is not limited to the order described in the present embodiment and can be changed as necessary.

The processor can be configured by one or a plurality of pieces of hardware. The type of hardware constituting the processor is not limited to a specific type. For example, the processor may be a central processing unit (CPU), a micro processing unit (MPU), a programmable logic device such as a field-programmable gate array (FPGA), a dedicated circuit for executing specific processing such as an application-specific integrated circuit (ASIC), a graphics processing unit (GPU), or hardware such as a neural processing unit (NPU).

The processor is not limited to a combination of a plurality of pieces of hardware of the same type and can also be configured by a combination of a plurality of pieces of hardware of different types. In a case where a plurality of pieces of hardware are configured to execute one or a plurality of types of processing of a certain processor, the plurality of pieces of hardware may be present in devices that are physically separate from each other or may be present in the same device. The hardware is configured by an electric circuit (circuitry) or the like in which circuit elements such as semiconductor elements are combined.

Also in any one of the embodiments, execution order of various types of processing by the processor is not limited to the order described in each of the embodiments and can be changed as necessary. The program may be software such as microcode in addition to firmware. The program may be, for example, a program module group. Each function constituting the program module group may be realized by a processor configured to execute each function. The program in each of the embodiments may be program codes or a plurality of code segments stored in one or a plurality of non-transitory computer readable media (for example, a semiconductor memory, a magnetic or optical storage medium, or other storage).

The program may be divided and stored in the plurality of non-transitory computer readable media present in devices that are physically separate from each other. The program code or the plurality of code segments can represent any combination of a procedure, a function, a subprogram, a routine, a subroutine, a module, a software package, a class, a command, a data structure, or a program statement. The program code or the plurality of code segments may be connected to other code segments or hardware circuits by transmitting and receiving information, data, an argument, a parameter, or memory content.

The memory 12 is a storage area that stores various types of software, data used for execution of software, and the like and is used as a work area during calculation. The memory 12 is configured by, for example, a random-access memory (RAM).

The storage unit 13 is a storage area that stores input data for various types of software, output data from various types of software, and the like. The storage unit 13 is configured to include, for example, a hard disk drive (HDD), a solid-state drive (SSD), a semiconductor memory, or the like used for storing a program, various types of setting data, or the like. The storage unit 13 is provided with a database for storing various types of information. Examples of the database provided in the storage unit 13 include a database in which a captured image of the material 200 captured by the imaging unit 17 and information related to the amount of moisture of the material 200 measured from the captured image of the material 200 are stored.

The communication unit 14 transmits and receives data between the preliminary drying machine 30 and the outside via the network 90. The operation unit 15 is configured by, for example, a keyboard, a mouse, a mechanical button, and a switch and receives an input operation of the worker. The operation unit 15 also includes a touch sensor that constitutes a touch panel integrally with the display unit 16.

The display unit 16 is configured by, for example, a liquid-crystal display or an organic electro luminescence (EL) display used for displaying information and displays data such as an image and text. For example, the display unit 16 may display text information indicating that the amount of moisture contained in the material 200 exceeds the threshold determined in advance or the like.

### Functional Configuration of Control Unit 11 of Injection Molding Machine 10

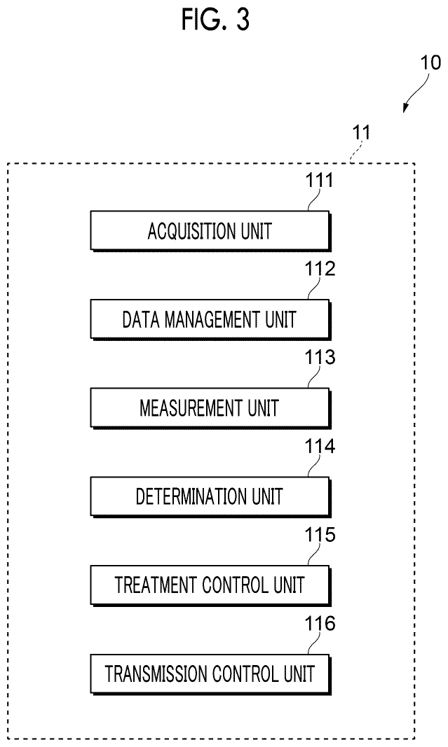

FIG. 3 is a diagram showing an example of a functional configuration of the control unit 11 of the injection molding machine 10.

In the control unit 11 of the injection molding machine 10, an acquisition unit 111 that acquires various types of information, a data management unit 112 that manages various types of information, and a measurement unit 113 that is measurement means for measuring the amount of moisture contained in the material 200 from a captured image of the material 200 function. In addition, in the control unit 11, a determination unit 114 that is determination means for determining the moisture amount improvement treatment, a treatment control unit 115 that is treatment control means for causing each unit to perform the moisture amount improvement treatment, and a transmission control unit 116 that transmits various types of information.

For example, the acquisition unit 111 acquires a captured image of the material 200 captured by the imaging unit 17 (see FIG. 1).

The data management unit 112 stores and manages various types of data in various types of databases provided in the storage unit 13 (see FIG. 2). For example, the data management unit 112 stores and manages the captured image acquired by the acquisition unit 111 in the database. In addition, the data management unit 112 manages a measurement result of the amount of moisture contained in the material 200, which is measured by the measurement unit 113 to be described later, in association with the captured image of the material 200.

The measurement unit 113 measures the amount of moisture contained in the material 200 from a captured image of the material 200. For example, the measurement unit 113 measures the amount of moisture based on brightness of each pixel constituting the captured image. In this case, the measurement unit 113 measures the amount of moisture by monitoring a change in a reflectance spectrum of the material 200. Herein, the “captured image” may be an image obtained by applying processing to the captured image. For example, the captured image may be an image obtained by performing primary differentiation on the captured image.

That is, since there is absorption of light mainly caused by the OH stretching vibration of water in the vicinity of a wavelength of a fundamental wave of 3,000 nm, and in the vicinity of a wavelength of a second harmonic wave of 1,450 nm, which is half of the wavelength of the fundamental wave, the reflectance spectrum of the material 200 containing moisture changes. For this reason, since a portion of a substance to be imaged (for example, the material 200 in the present embodiment), which contains water, absorbs a large amount of light having a wavelength in the vicinity of 1,450 nm, the amount of light to be reflected decreases. On the other hand, since the portion of the substance to be imaged, which does not contain water, reflects light having a wavelength of approximately 1,450 nm without absorbing the light, the amount of light to be reflected increases. Accordingly, a change in the distribution of light and shade of a color or a change in the distribution of a difference in color based on the amount of moisture contained in the substance to be imaged can be monitored from the captured image.

In addition, the measurement unit 113 may divide at least a part of a region of a captured image of the material 200 into a plurality of measurement regions and measure the amount of moisture contained in the material 200 for each of the divided measurement regions. Since the captured image is captured as described above on the surface of a group of the materials 200, the amount of moisture contained in the captured material 200 is not constant and is usually distributed over the entire captured image. For this reason, the measurement unit 113 divides at least a part of the region of the captured image into the plurality of measurement regions and calculates an average of brightness values of pixels for each of the divided measurement regions. Then, in a case where the average of the brightness values of at least one measurement region among the divided measurement regions exceeds a threshold determined in advance, the measurement unit 113 treats the average of the brightness values as a representative value.

The determination unit 114 determines the moisture amount improvement treatment according to the measured amount of moisture of the material 200. For example, the determination unit 114 determines to notify the worker of the fact that the amount of moisture contained in the material 200 exceeds the threshold determined in advance as the moisture amount improvement treatment. In addition, the determination unit 114 determines that the material 200 is returned to the preliminary drying machine 30 as the moisture amount improvement treatment. In addition, the determination unit 114 determines to perform additional drying of the material 200 as the moisture amount improvement treatment.

The treatment control unit 115 controls the determined moisture amount improvement treatment. For example, the treatment control unit 115 notifies the worker of the fact that the amount of moisture contained in the material 200 exceeds the threshold determined in advance as the moisture amount improvement treatment. In addition, the treatment control unit 115 causes the material return unit 18 to perform a treatment to return the material 200 to the preliminary drying machine 30 as the moisture amount improvement treatment. In addition, the treatment control unit 115 causes the additional drying unit 19 to perform additional drying of the material 200 as the moisture amount improvement treatment.

The transmission control unit 116 performs control of causing the communication unit 14 (see FIG. 2) to transmit various types of information to the preliminary drying machine 30 that constitutes the network 90. For example, in a case where the preliminary drying machine 30 operates based on control information from the injection molding machine 10, the transmission control unit 116 performs control of causing the control information for operating the preliminary drying machine 30 to be transmitted to the preliminary drying machine 30.

### Flow of Treatment of Injection Molding Machine 10

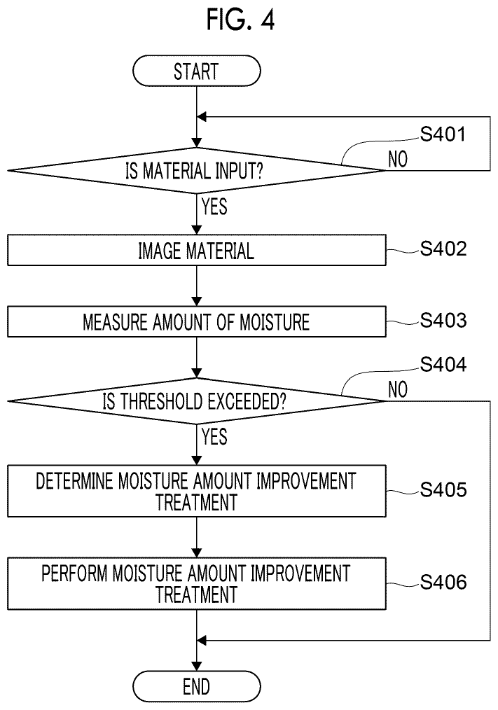

FIG. 4 is a flowchart showing an example of a flow of a treatment in the injection molding machine 10. In addition, FIG. 4 shows an example of a flow of a treatment in a case where the moisture amount improvement treatment is performed when the measured amount of moisture of the material 200 exceeds the threshold determined in advance.

In the injection molding machine 10, when the material 200 that has been subjected to preliminary drying by the preliminary drying machine 30 (see FIG. 1) is input (YES in step S401), the imaging unit 17 images the material 200 (step S402). On the other hand, in a case where the material 200 is not input to the input port 51 (NO in step S401), the injection molding machine 10 repeats determination processing in step S401.

In the injection molding machine 10, the measurement unit 113 measures the amount of moisture contained in the material 200 from a captured image of the material 200 in step S402 (step S403). In this case, when the amount of moisture contained in the material 200 exceeds the threshold determined in advance (YES in step S404), the determination unit 114 determines the moisture amount improvement treatment (step S405). Then, the treatment control unit 115 performs the moisture amount improvement treatment determined in step S404 (step S406) and ends the treatment (END). On the other hand, in a case where the amount of moisture contained in the material 200 does not exceed the threshold determined in advance (NO in step S404), the determination unit 114 ends the treatment without determining the moisture amount improvement treatment (END).

### SPECIFIC EXAMPLE

### Specific Example of Imaging Region

FIG. 5 is a diagram showing a specific example of an imaging region 170 of the imaging unit 17.
FIG. 5 shows a state when the input port 51 of the injection molding machine 10 (see FIG. 1) is viewed from the upper side toward the lower side in the vertical direction. As described above, the imaging unit 17 (see FIG. 1) of the injection molding machine 10 images the opening portion 511 of the input port 51 from the upper side in the vertical direction. For this reason, the imaging region 170 viewed from the imaging unit 17 has a state shown in FIG. 5. In FIG. 5, the drawing of a portion other than the input port 51 is omitted.

The hatched region shown in FIG. 5 shows the surface of the group of materials 200 input to the input port 51, which is on the upper side in the vertical direction. That is, the imaging unit 17 of the injection molding machine 10 images the surface of the group of materials 200 input to the input port 51, which is on the upper side in the vertical direction, as an imaging target. A region 171 divided into nine sections and shown in FIG. 5 is a region that the injection molding machine 10 targets for measurement of the amount of moisture based on the captured image.

In the case of the example of FIG. 5, the injection molding machine 10 measures the amount of moisture from the captured image of the material 200 contained in each of the nine measurement regions. Then, in a case where a measurement result of the amount of moisture of the material 200 contained in at least one measurement region of the nine measurement regions exceeds the threshold determined in advance, the amount of moisture is treated as a representative value, and the moisture amount improvement treatment is determined. The nine measurement regions shown in FIG. 5 are merely an example. For example, the amount of moisture may be measured from the captured image of the material 200 contained in each of four measurement regions divided in a 2×2 manner or the amount of moisture from the captured image of the material 200 included in each of 16 measurement regions divided in a 4 ×4 manner.

### Specific Example of Method of Measuring Amount of Moisture From Captured Image

FIG. 6A is a diagram showing an example of a captured image captured by a hyperspectral camera which is an example of the imaging unit 17. FIG. 6B is an image obtained by performing primary differentiation on the captured image of FIG. 6A.

FIG. 6A shows an example of a captured image of a material and a cloth on which the material is placed, which is captured by a hyperspectral camera having sensitivity to light having a wavelength of 1,400 nm. FIG. 6B shows an example of an image in which the amount of moisture is easily measured by performing primary differentiation on the captured image of FIG. 6A. The reason why the cloth is included in the captured image is to compare the cloth that is more likely to contain water than the material. That is, the captured image shown in FIG. 6A is not an image captured in the imaging region 170 shown in FIG. 5 described above but is for describing a method of measuring the amount of moisture.

From the captured image shown in FIG. 6A, the distribution of a color shade can be visually recognized. In addition, the distribution of the color shade and the distribution of a color difference can be visually recognized from the image shown in FIG. 6B obtained by performing primary differentiation on the captured image shown in FIG. 6A. As described above, the injection molding machine 10 (see FIG. 1) measures the amount of moisture based on the brightness of each pixel constituting the captured image (including the image obtained by performing primary differentiation on the captured image). That is, since a difference in the brightness of the pixels occurs between a portion of the captured image containing water and a portion of the captured image not containing water, visual discrimination is possible. For example, as shown in FIGS. 6A and 6B, since the brightness of a portion of a material that is drier is higher than the brightness of a portion of a material that is wetted in the captured image, both portions can be distinguished from each other. In particular, it is preferable that the image of FIG. 6B is easy to visually recognize compared to the captured image of FIG. 6A before the primary differentiation.

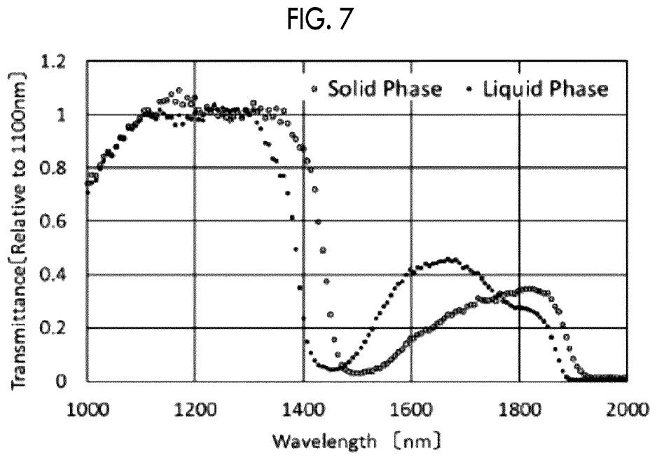

FIG. 7 is a graph showing an absorption spectrum in a solid phase and a liquid phase.

FIG. 7 shows a relationship between a wavelength on a horizontal axis and transmittance on a vertical axis. It is preferable to use a wavelength that has high transmittance of water as a wavelength used in measuring the amount of moisture. When the graph of FIG. 7 is viewed with regard to this point, a valley of the transmittance (a region where the transmittance is low) is observed at a wavelength of 1,400 to 1,500 nm. This is because there is a valley of the transmittance at a wavelength of 2,800 to 3,000 nm (not shown) and the wavelength of 1,400 to 1,500 nm corresponds to a second harmonic wave of the wavelength of 2,800 to 3,000 nm. In addition, a valley of transmittance is also viewed at a wavelength in the vicinity of 1,900 nm. However, this is because it is difficult to measure an accurate value due to the performance of the device, and actual transmittance is higher than the value shown in the graph of FIG. 7.

From the above, it is preferable to use a wavelength of 2,800 to 3,000 nm or a second harmonic wave thereof as a wavelength used in measuring the amount of moisture.

In summary, the injection molding system 1 according to the present embodiment may have the following configuration and can take various types of embodiments.

That is, the injection molding system 1 is an injection molding system having the imaging unit 17 that is imaging means for imaging the material 200 for injection molding that has been subjected to preliminary drying before being input to the input port 51 of the injection molding machine 10, when being input to the input port 51, the measurement unit 113 that is measurement means for measuring the amount of moisture contained in the material 200 from a captured image of the material 200, the determination unit 114 that is determination means for determining moisture amount improvement treatment for improving the amount of moisture contained in the material 200 according to the measured amount of moisture, and the treatment control unit 115 that is treatment control means for causing the determined moisture amount improvement treatment to be performed.

Accordingly, the amount of moisture of the material 200 is measured from the captured image of the material 200 captured when the material 200 is input to the input port 51 of the injection molding machine 10, and the moisture amount improvement treatment according to the measured amount of moisture is performed. For this reason, for example, in a case where drying insufficiency of the material 200 is recognized from the measured amount of moisture, a treatment for resolving the drying insufficiency of the material 200 is performed. As a result, occurrence of a molding defect of the molding product 210 caused by the drying insufficiency of the material 200 can be suppressed.

Herein, the determination unit 114 may determine the moisture amount improvement treatment in a case where the measured amount of moisture exceeds the threshold determined in advance.

Accordingly, the moisture amount improvement treatment is determined in a case where the measured amount of moisture exceeds the threshold determined in advance. For this reason, for example, in a case where the threshold is determined to be a degree that a molding defect caused by drying insufficiency of the material 200 is predicted, the worker can be notified of this or the operation of the injection molding machine 10 is stopped as the moisture amount improvement treatment. In addition, for example, in a case where the threshold is determined to have a margin to a degree that occurrence of a molding defect caused by drying insufficiency of the material 200 can be prevented in advance, as the moisture amount improvement treatment, the material 200 can be returned to the preliminary drying machine 30 without stopping the operation of the injection molding machine 10 or the material 200 can be additionally dried. As a result, occurrence of a molding defect of the molding product 210 caused by the drying insufficiency of the material 200 can be suppressed.

In addition, the determination unit 114 may determine to notify that the measured amount of moisture exceeds the threshold determined in advance as the moisture amount improvement treatment.

Accordingly, since the worker can be notified that the amount of moisture contained in the material 200 exceeds the threshold determined in advance, the worker can take an early measure.

In addition, the preliminary drying machine 30 that performs preliminary drying of the material 200 and the material return unit 18 that is material return means for returning the material 200, which has been subjected to the preliminary drying and has been input to the input port 51, to the preliminary drying machine 30 may be further included. The determination unit 114 may determine to return the material 200, which is input to the input port 51, to the preliminary drying machine 30 with the material return unit 18 as the moisture amount improvement treatment.

Accordingly, since the material 200 input to the injection molding machine 10 is returned to the preliminary drying machine 30 and is redried, a molding defect of the molding product 210 caused by drying insufficiency of the material 200 can be suppressed without stopping the operation of the injection molding machine 10.

In addition, the additional drying unit 19 that is additional drying means for performing additional drying of the material 200 input to the input port 51 may be further included, and the determination unit 114 may determine to cause the additional drying unit 19 to perform additional drying as the moisture amount improvement treatment.

Accordingly, since the material 200 that has been input to the injection molding machine 10 is additionally dried, a molding defect of the molding product 210 caused by drying insufficiency of the material 200 can be suppressed without stopping the operation of the injection molding machine 10.

In addition, the measurement unit 113 may divide at least a part of the region (for example, the region 171 in FIG. 5) of a captured image of the material 200 into a plurality of (for example, nine) measurement regions and measure the amount of moisture contained in the material 200 for each measurement region.

Accordingly, at least a part of the region of the captured image is divided into the plurality of measurement regions, and the amount of moisture is measured for each of the divided measurement regions. Therefore, for example, a measurement result of one measurement region of the divided measurement regions can be treated as a representative value. As a result, the amount of moisture can be measured based on the captured image in which the distribution of the amount of moisture of the material 200, which is an imaging target, is not constant.

In addition, the imaging unit 17 may be a multi-wavelength spectroscopic camera.

Accordingly, a camera that is sensitive to light having a wavelength of a fundamental wave in the vicinity of 3,000 nm and a wavelength of a second harmonic wave which is half of the wavelength of the fundamental wave in the vicinity of 1,450 nm, at which absorption of light mainly caused by OH stretching vibration of water occurs, can be adopted. As a result, the amount of moisture contained in the material 200, which is an imaging target, can be visualized in a captured image.

In addition, the injection molding machine 10 according to the present embodiment may have the following configuration and can take various types of embodiments. That is, the injection molding machine 10 is an injection molding machine having the imaging unit 17 that is imaging means for imaging the material 200 for injection molding that has been subjected to preliminary drying before being input to the input port 51, when being input to the input port 51, the measurement unit 113 that is measurement means for measuring the amount of moisture contained in the material 200 from a captured image of the material 200, the determination unit 114 that is determination means for determining moisture amount improvement treatment for improving the amount of moisture contained in the material 200 according to the measured amount of moisture, and the treatment control unit 115 that is treatment control means for causing the determined moisture amount improvement treatment to be performed.

In addition, an injection molding method according to the present embodiment may have the following configuration and can take various types of embodiments. That is, the injection molding method according to the present embodiment is an injection molding method including a step of imaging the material 200 for injection molding that has been subjected to preliminary drying before being input to the input port 51 of the injection molding machine 10, when being input to the input port 51, a step of measuring the amount of moisture contained in the material 200 from a captured image of the material 200, a step of determining moisture amount improvement treatment for improving the amount of moisture contained in the material 200 according to the measured amount of moisture, and a step of causing the determined moisture amount improvement treatment to be performed.

In addition, the program according to the present embodiment may have the following configuration and can take various types of embodiments. That is, the program according to the present embodiment is a program for causing a computer to realize a function of imaging the material 200 for injection molding that has been subjected to preliminary drying before being input to the input port 51 of the injection molding machine 10, when being input to the input port 51, a function of measuring the amount of moisture contained in the material 200 from a captured image of the material 200, a function of determining moisture amount improvement treatment for improving the amount of moisture contained in the material 200 according to the measured amount of moisture, and a function of causing the determined moisture amount improvement treatment to be performed.

### Other

Although the embodiment of the present invention has been described hereinbefore, the present invention is not limited to the embodiment described above. In addition, effects of the present invention are also not limited to those described in the embodiment described above. For example, the overall configuration of the injection molding system of FIG. 1, the hardware configuration of the injection molding machine 10 of FIG. 2, and the functional configuration of the injection molding machine 10 of FIG. 3 are all merely examples for implementing the present invention, and are not particularly limited.

In addition, the order of the steps of the treatment of the injection molding machine 10 shown in the flowchart of FIG. 4 is also merely an example and is not particularly limited. The treatment is not only performed in time series in accordance with the order of the shown steps, but also need not necessarily be performed in time series and may be performed in parallel or individually.

In addition, the specific examples shown in FIGS. 5 and 6 are also merely examples. For example, an example in which the region 171 included in a captured image of the material 200 is divided into a plurality of measurement regions, and the amount of moisture contained in the material 200 is measured for each measurement region is shown in FIG. 5. However, the present invention is not limited thereto. For example, the amount of moisture may be measured from the captured image without dividing the captured image into the plurality of measurement regions.

It should be understood that the invention is not limited to the above-described embodiment, but may be modified into various forms on the basis of the spirit of the disclosure. Additionally, the modifications are included in the scope of the disclosure.

What is claimed is:

1. An injection molding system comprising:
an image capturer configured to image a material for injection molding that has been subjected to preliminary drying before being input to an input port of an injection molding machine, when the material is input to the input port;
a measurer configured to measure an amount of moisture contained in the material from a captured image of the material;
a determiner configured to determine a treatment for improving the amount of moisture according to the amount of moisture that is measured; and
a treatment controller configured to cause the treatment, which is determined, for improving the amount of moisture to be performed.

2. The injection molding system according to claim 1,
wherein the determiner determines the treatment for improving the amount of moisture in a case where the amount of moisture exceeds a threshold determined in advance.

3. The injection molding system according to claim 2,
wherein the determiner determines to notify that the amount of moisture exceeds the threshold as the treatment for improving the amount of moisture.

4. The injection molding system according to claim 1, further comprising:
a preliminary drying machine configured to perform the preliminary drying; and
a material returner configured to return the material, which has been subjected to the preliminary drying and has been input to the input port, to the preliminary drying machine,
wherein the determiner determines to return the material to the preliminary drying machine with the material returner as the treatment for improving the amount of moisture.

5. The injection molding system according to claim 1, further comprising:
an additional dryer configured to perform additional drying of the material input to the input port,
wherein the determiner determines to cause the additional dryer to perform the additional drying as the treatment for improving the amount of moisture.

6. The injection molding system according to claim 5,
wherein the additional dryer is disposed close to a discharge port of the input port and performs the additional drying of the material passing through the discharge port.

7. The injection molding system according to claim 1,
wherein the measurer divides at least a part of a region of the captured image of the material into a plurality of measurement regions and measures the amount of moisture contained in the material for each of the measurement regions.

8. The injection molding system according to claim 1,
wherein the image capturer is a multi-wavelength spectroscopic camera.

9. The injection molding system according to claim 1,
wherein the treatment controller notifies a worker that the amount of moisture contained in the material exceeds a threshold determined in advance as the treatment for improving the amount of moisture.

10. An injection molding machine comprising:
an image capturer configured to image a material for injection molding that has been subjected to preliminary drying before being input to an input port, when the material is input to the input port;
a measurer configured to measure an amount of moisture contained in the material from a captured image of the material;
a determiner configured to determine a treatment for improving the amount of moisture according to the amount of moisture that is measured; and
a treatment controller configured to cause the treatment, which is determined, for improving the amount of moisture to be performed.

11. An injection molding method comprising:
imaging a material for injection molding that has been subjected to preliminary drying before being input to an input port of an injection molding machine, when the material is input to the input port;
measuring an amount of moisture contained in the material from a captured image of the material;
determining a treatment for improving the amount of moisture according to the amount of moisture that is measured; and
causing the treatment, which is determined, for improving the amount of moisture to be performed.

12. A non-transitory computer readable storage medium storing a program that causes a computer to execute a process comprising:
imaging a material for injection molding that has been subjected to preliminary drying before being input to an input port of an injection molding machine, when the material is input to the input port;
measuring an amount of moisture contained in the material from a captured image of the material;
determining a treatment for improving the amount of moisture according to the amount of moisture that is measured; and
causing the treatment, which is determined, for improving the amount of moisture to be performed.
